(19) United States
(12) Patent Application Publication
(10) Pub. No.: US 2008/0043957 A1
(43) Pub. Date: Feb. 21, 2008

(54) System and method for allowing a communication device to have multiple, hierarchically prioritized numbers

(75) Inventor: Kyle Feng Guo, Qingdao (CN)

Correspondence Address: HARNESS, DICKEY & PIERCE, P.L.C., P.O. BOX 8910, RESTON, VA, 20195, US

(73) Assignee: Lucent Technologies Inc.

(21) Appl. No.: 11/633,432

(22) Filed: Dec. 5, 2006

(30) Foreign Application Priority Data
Jul. 7, 2006 (CN) 200610143148.6

(51) Int. Cl. H04M 3/42

(52) U.S. Cl. 379/201.01

(57) ABSTRACT

A method and system for processing a call in a communication system. The method includes the steps of determining a priority of a received call based on a list of multiple, hierarchically prioritized directory numbers associated with a call communication device and handling the received call based on the priority of the received call and the priority setting of the called communication device. The communication system includes a user database and a network switch/register. The user database stores multiple, hierarchically prioritized directory numbers associated a communication device and a priority of each directory number associated with the communication device. The network switch handles calls directed to one of the hierarchically prioritized directory numbers based on the priority of a received call and a priority setting of the called communication device.

### PRIORITY STATEMENT

This non-provisional U.S. patent application claims priority under 35 U.S.C. § 119 to Chinese Patent Application No. 200610143148.6 filed on Jul. 7, 2006, the entire contents of which are incorporated herein by reference.

### BACKGROUND OF INVENTION

1. Field of the Invention

The present invention is related to a system and method for telecommunications. More particularly, the present invention relates to a system and method for allowing a communication device to have multiple, hierarchically prioritized telephone numbers.

2. Background Information

With the advent of sophisticated telecommunication services, telecommunication subscribers frequently experience the reception of unwanted or otherwise undesirable telephone calls. For example, telemarketers frequently use computerized calling procedures, which often interrupt subscribers at unwanted times, such as at meal times.

Further, many subscribers only want to be contacted by certain groups of people at certain times. For example, when a subscriber is at work the subscriber may only wish to be contacted by coworkers, customers and/or family. As another example, once a subscriber retires to sleep for the evening, the subscriber may only wish to receive telephone calls from a select group of people, for example, family members.

Conventional telecommunications services and communication devices allow subscribers to manually screen incoming calls, using a caller identification (“caller ID”) system, after they have been alerted of the incoming call, typically by an incoming ring. However, under such circumstances, the subscriber is still interrupted from their current activity, and must personally examine the incoming caller identification information to determine whether or not to answer the incoming call.

Another conventional method of call screening includes use of telephone answering and message recording machines. According to this method, the subscriber may allow the telephone answering and message recording machine to answer and then listen to the message as the message is being recorded. The subscriber may listen to the message while it is being recorded and choose to answer the call at that time. Again, the subscriber has been interrupted from his or her current activity, and must also personally listen to the incoming message to screen the call. In addition, this type of call screening is unavailable to subscribers utilizing centralized voicemail systems, which typically do not broadcast the audible message as it is being recorded.

As a consequence, a need remains for an apparatus, method and system that may be used by a telecommunication subscriber to automatically screen incoming calls.

### SUMMARY OF THE INVENTION

One or more example embodiments of the present invention are directed towards a system and method for allowing a communication device to have multiple, hierarchically prioritized directory numbers.

An example embodiment of the present invention provides a method of processing a received call in a communication system. The method includes the steps of determining a priority of the received based on a list of multiple, hierarchically prioritized directory numbers associated with a called communication device and handling the received call based on the determining step.

According to an example embodiment of the present invention, the handling step handles the received call based on the determined priority of the received call and a priority setting of the called communication device. The handling step screens the call if the determined priority of the received call is lower than the priority setting of the called communication device. The handling step sends the received call to the called communication device if the determined priority of the received call is higher or the same as the priority setting of the called communication device.

According to an example embodiment of the present invention, the method may also include the steps of obtaining a subscriber record if the received call is directed to a directory number that is one of multiple, hierarchically prioritized telephone numbers associated with the called communication device and determining the priority of the received call based on the subscriber record.

According to an example embodiment of the present invention, the priority setting of the called communication device may be detected from the subscriber record of based on an operating mode of the communication device.

According to an example embodiment of the present invention, the method may also include registering multiple directory numbers for the communication device and assigning each of the multiple directory numbers with the priority used in the processing step.

Another example embodiment of the present invention provides a communication system. The communication system includes a user database and a network switch/register. The user database stores multiple, hierarchically prioritized directory numbers associated a communication device and a priority of each directory number associated with the communication device. The network switch handles calls directed to one of the hierarchically prioritized directory numbers based on the priority of a received call and a priority setting of the called communication device.

According to an example embodiment of the present invention, the network switch/register includes a transceiver, memory and computer processing unit (CPU). The transceiver receives calls. The memory stores a subscriber list of directory numbers. The CPU determines if a received call is directed to a telephone number included in the subscriber list of telephone numbers, instructs the transceiver to obtain a subscriber record associated with the directory number from the user database if the directory number is included in the subscriber list of telephone numbers and handles the received call based on the subscriber record. The subscriber record indicates if multiple, hierarchically prioritized directory numbers are associated with a communication device and a priority of the called directory number, which is used as the priority of the received call.

According to an example embodiment of the present invention, the CPU handles the received call by detecting a priority setting of the communication device, comparing the priority setting of the communication device to the priority of the received call, and connects the received call to the communication device if the priority of the received call is the same or higher than the priority setting of the communication device. Alternatively, the CPU indicates the communication device is unavailable if the priority of the received call is lower than the priority setting of the communication device.

### BRIEF DESCRIPTION OF THE DRAWINGS

Example embodiments of the present invention will become more fully understood from the detailed description given herein below and the accompanying drawings, wherein like elements are represented by like reference numerals, which are given by way of illustration only and thus, are not limiting of the present invention and wherein:

FIG. 1 is a block diagram of a communication system for implementing an example embodiment of the present invention;

FIG. 2 is a flow chart illustrating a method performed by a network switch according to an example embodiment of the present invention;

FIG. 3 is a communication flow diagram of a power-on registration process according to an example embodiment of the present invention;

FIG. 4 is a communication flow diagram of a call made from a first mobile terminal to a second mobile terminal having multiple, hierarchically prioritized numbers when the call is screened according to an example embodiment of the present invention;

FIG. 5 is a communication flow diagram of a call made from a first mobile terminal to a second mobile terminal having multiple, hierarchically prioritized numbers when the call is connected according to an example embodiment of the present invention;

FIG. 6 is a communication flow diagram of a call made from a first mobile terminal having multiple, hierarchically prioritized numbers to a second mobile terminal according to an example embodiment of the present invention;

FIGS. 7A-7C is a communication flow diagram of a power on registration process in a Internet Protocol Multimedia Subsystem (IMS) according to an example embodiment of the present invention;

FIG. 8 is a communication flow diagram of a call made from a first IMS terminal having multiple, hierarchically prioritized addresses according to an example embodiment of the present invention;

FIG. 9 is a communication flow diagram of a call made from a first IMS mobile terminal to a second IMS terminal having multiple, hierarchically prioritized addresses when the call is accepted according to an example embodiment of the present invention; and

FIG. 10 is a communication flow diagram of a call made from a first IMS terminal to a second IMS terminal having multiple, hierarchically prioritized addresses when the call is screened according to an example embodiment of the present invention.

### DETAILED DESCRIPTION OF EXAMPLE EMBODIMENTS

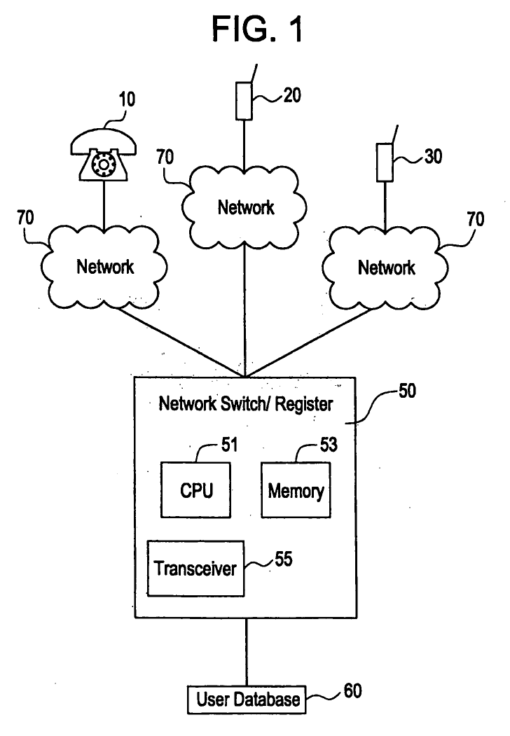

FIG. 1 is a block diagram of an example communication system suitable for implementing a method for allowing a communication device to be assigned a plurality of directory numbers, which are hierarchically assigned to the communication device.

Referring to FIG. 1, the communication system includes communication networks 70 coupled between communication devices and a network switch/register 50. The communication networks 70 may be a wireless network, a landline network or a combination thereof. In FIG. 1, the communication devices are shown as wireless mobile terminals 20, 30 and a landline terminal 10. However, it is noted that various types of “calls” and various types of “communication devices” fall within the scope of the invention. For example, “communication devices” may include landline terminals, wireless mobile terminals, personal digital assistants (PDAs), facsimile machines, dedicated answering machines such as a voice mailbox, etc. Further, a “call” may take the form of a voice transmission from a wireless mobile terminal, data transmission from a computer, a fax transmission from a facsimile machine, etc. Further, the “call” may refer to a packet-switched call or circuit-switched call.

It is also noted that there are many well-known ways to couple calls between communication devices and/or elements of a network. Examples of such coupling, all of which are suitable for use in the present invention, are standard telephone lines, twisted shielded pair lines, coaxial cables, fiber optic lines, wireless links, etc.

As shown in FIG. 1, the network switch/register 50 includes a central processing unit (CPU) 51 and a memory 53 for performing various tasks of the network switch/register 50. The network switch/register 50 also includes a transceiver 55 for communicating data to and from various external devices such as the landline terminal 10, wireless mobile terminals 20, 30 and the user database 60. The network switch/register 50 routes calls received from a first communication device such as the landline terminal 10 to a second communication device such as the wireless mobile terminal 20.

The network switch/register 50 is connected to the communication networks 70 as well as a user database 60. In, FIG. 1 the user database 60 is illustrated as an external unit connected to the network switch/register 50. However, it should be noted that the user database 60 may also be incorporated into the network switch/register 50. The user database 60 stores records related to a terminal and user. For example, a user record may include identification information of the user and services subscribed to by the user for a mobile terminal 20 associated with the user.

According to an example embodiment of the present invention, one of the services provided by a service provider, for example, a telephone company, allows a user to associate multiple telephone numbers with a communication device, such as the wireless mobile terminal 20. Further, the multiple numbers may be prioritized to create a hierarchy of the multiple numbers associated with the wireless mobile terminal 20.

For example, a user associated with the mobile terminal 20 may subscribe to a service, which permits the user to associate three different numbers with the mobile terminal 20. The three numbers associated with the mobile terminal 20 may be prioritized. A first number (111) 111-1111 may be assigned the highest priority, a second number (111) 111-1112 may be assigned a high priority and a third number may be assigned a low priority (111) 111-1113.

According to an example embodiment of the present invention, the user database 60 is used to store multiple numbers associated with various communication devices and a priority of the multiple numbers associated with each communication device. For example, a service provider may update the user database 60 when a subscriber subscribes to the service for associating multiple numbers with a communication device.

According to an example embodiment of the present invention, a communication device having multiple numbers operates in a plurality of different modes. For example, the mobile terminal 20 operates in one of three modes including a public mode, a family mode and a private mode. The public mode permits all calls made to any of the three numbers associated with mobile terminal 20 to connect to the mobile terminal 20. In other words, a calling party dialing any of the highest priority first number (111) 111-1111, the high priority second number (111) 111-1112 and the low priority third number (111) 111-1113 is connected to the mobile terminal 20.

The family mode permits only calls made to the highest priority first number (111) 111-1111 and the high priority second number (111) 111-1112 to connect to the mobile terminal 20. In other words, only a calling party that dials a number assigned a high priority or highest priority is connected to the mobile terminal 20. A calling party dialing the low priority third number (111) 111-1113 will not be connected to the mobile terminal 20. For example, a calling party dialing the low priority number when the mobile terminal 20 is operating in the family mode will receive a message indicating the subscriber is unavailable, a busy signal, or be forwarded directly to a messaging service. Accordingly, if a subscriber does not wish to be bothered by a group of people having only the low priority third number, the subscriber may simply switch the operating mode of mobile terminal 20 to family mode.

The private mode permits only calls made to the highest priority first number (111) 111-1111 to connect to the mobile terminal 20. In other words, only a calling party that dials a number assigned a highest priority is connected to the mobile terminal 20. A calling party dialing the low priority third number (111) 111-1113 or high priority second number (111) 111-1112 will not be connected to the mobile terminal 20. For example, a calling party dialing the low priority number or high priority number receives a message indicating the subscriber is unavailable, a busy signal, or is forwarded directly to a messaging service. Accordingly, if a subscriber does not wish to be bothered by a group of people having the low priority third number (111) 111-1113 or the high priority second number (111) 111-1112, the subscriber may simply switch the operating mode of mobile terminal 20 to private mode.

The operating mode of a communication device is selected by the subscriber. For example, the subscriber may select the operating mode of the mobile terminal 20 using a menu provided by the mobile terminal 20, which may operate similar to a menu permitting a subscriber to obtain a telephone number or address stored in a mobile terminal's address book. Alternatively, a separate button may be provided on the mobile terminal 20 for selecting the operating mode of the mobile terminal 20, which triggers the mobile terminal 20 to switch operating modes.

According to an example embodiment of the present invention, the communication device also permits the subscriber to determine which number is displayed by a called party's caller ID. For example, because the subscriber does not want everyone the subscriber calls to have the highest priority first number (111) 111-1111, the subscriber may set the communication device to always display the low priority third number (111) 111-1113 when the subscriber makes calls regardless of the mode in which the mobile terminal 20 is operating.

As briefly mentioned above, the network switch/register 50 controls the routing of calls received from a first communication device such as the landline terminal 10 to a second communication device such as the mobile terminal 20.

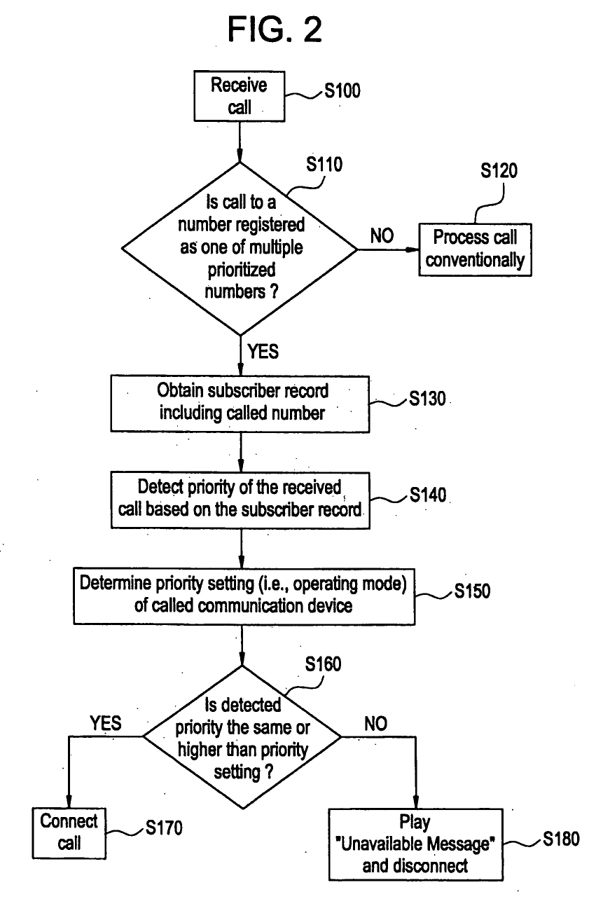

FIG. 2 is a flow chart illustrating a method for routing calls to a communication device associated with multiple, hierarchically prioritized numbers according to an example embodiment of the present invention, which may be performed by the network switch/register 50.

As shown in step S100, the transceiver 55 of the network switch/register 50 receives a call. For example, a calling party dials the high priority second number (111) 111-1112 associated with the mobile terminal 20 using the landline terminal 10, and the transceiver 55 receives the call from the landline terminal 10 via a communication network 70.

In step S110, the network switch/register 50 determines if the received call is to a number registered as one of multiple numbers associated with a common communication device. In particular, the CPU 51 of the network switch/register 50 compares the number dialed by the calling party using the landline terminal 10 to a subscriber list of numbers stored in the memory 53. The subscriber list of numbers includes numbers of subscribers that have registered for one or more services provided by the service provider. For example, when a subscriber registers for one or more services provided by a service provider, the service provider may update the subscriber list of numbers to include the subscriber's number. For example, if a subscriber registers the mobile terminal 20 for the service allowing multiple, hierarchically prioritized numbers to be associated with the mobile terminal 20, the multiple numbers of the mobile terminal 20 are included in the subscriber list of numbers. Further, the service provider creates a subscriber record indicating that the mobile terminal 20 has multiple, hierarchically prioritized numbers and the priority assigned to each of the multiple, hierarchically numbers. The subscriber records are stored in the user database 60.

If the network switch/register 50 determines the received call is directed to a number that is not in the list of subscriber numbers, the call is processed in a conventional manner as shown by step S120 of FIG. 2.

Alternatively, if the CPU 51 of the network switch/register 50 determines the received call is directed to a number included in the subscriber list of numbers in step S110 of FIG. 2, the CPU 51 obtains the subscriber record associated with the number as shown by step S130. For example, if the received call is directed to the high priority second number (111) 111-1112 of the mobile terminal 20, the CPU 51 obtains the subscriber record including the number (111) 111-1112 from the user database 60 via the transceiver 55.

In step S140, the CPU 51 detects the priority of the called number based on the subscriber record. The CPU 51 uses the priority of the called number as the priority of the received call. For example, the subscriber record for mobile terminal 20 indicates the second number (111) 111-1112 has a high priority so the received call is treated as a high priority call.

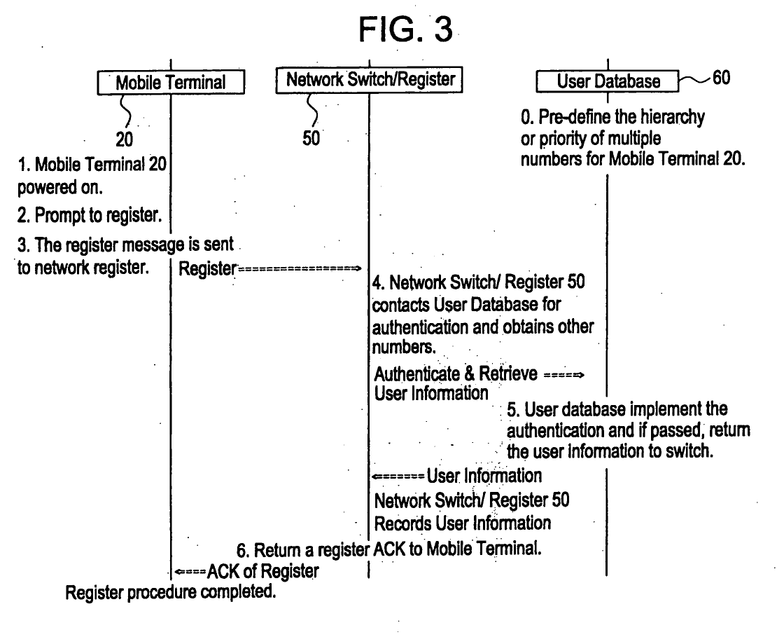

The CPU 51 then determines the priority setting of the communication device by detecting the operating mode of the communication device. The operating mode of the communication device may be determined based on a registration procedure. It is noted a communication device registers with the network switch/register 50 at various times. For example, the communication device may routinely register with the network switch/register 50 at specified time intervals and/or may register with the network switch/register 50 based on triggering events such as powering-on, a change in operating mode, etc. The registration procedure will be described in further detail below with respect to FIG. 3.

For example, based on registration procedure the network switch/register 50 may determine if the mobile terminal 20 is operating in a public mode, family mode or private mode. As previously described, if the mobile terminal 20 is operating in the public mode, all calls are routed to the mobile terminal 20; if the mobile terminal 20 is operating in the family mode, only calls directed to the highest priority first number (111) 111-1111 and the high priority second number (111) 111-1112 are routed to the mobile terminal 20; and if the mobile terminal 20 is operating in the private mode, only calls directed to the highest priority first number (111) 111-1111 are routed to the mobile terminal 20.

Once the CPU 51 of the network switch/register 50 detects the priority of the received call in step S140 and determines the priority setting of the called communication device in step S150, the CPU 51 determines if the detected priority of the received call is equal to higher than the priority setting of the called communication device in step S160.

If in step S160, the CPU 51 of the network switch/register 50 determines the detected priority of the received call is lower than the detected priority setting of the called communication device, the calling party receives a message indicating the subscriber is unavailable in step S180. For example, if the CPU 51 determines the mobile terminal 20 is operating in private mode and the calling party called the high priority second number (111) 111-1112, the calling party receives the message indicating the subscriber is unavailable. It is noted that instead of or in addition to the calling party receiving the message indicating the subscriber is unavailable, the calling party may receive a busy signal or be forwarded directly to a messaging service in step S180.

If, in step S160, the CPU 51 of the network switch/register 50 determines the detected priority of the received call is equal to or higher than the detected priority setting determined based on the operating mode of the called communication device, the call is routed to the called communication device as shown by step S170. For example, if the CPU 51 determines the mobile terminal 20 is operating in public mode or family mode and the calling party called the high priority second number (111) 111-1112, the call is routed to the mobile terminal 20.

The communication flow diagrams of FIGS. 3-6 described below provide examples of the communication flow according to an example embodiment of the present invention.

FIG. 3 illustrates a power on registration process occurring between the mobile terminal 20, a network switch/register 50 and a user database 60 according to an example embodiment of the present invention.

As shown in FIG. 3, multiple, hierarchically prioritized numbers may be associated with the mobile terminal 20. For example, the hierarchy and priority of the multiple numbers may be pre-defined in the user database 60 when a user of the mobile terminal 20 subscribes to the service allowing the user to associate multiple numbers with the mobile terminal 20.

When the mobile terminal 20 is powered-on, the mobile terminal prompts the user to register one of the hierarchically prioritized numbers associated with the mobile terminal 20 and/or identify the operating mode of the mobile terminal 20. In response to the prompt, the user may enter the high priority second number (111) 111-1112, for example. The mobile terminal 20 sends the register message to the network switch/register 50. The network switch/register 50 contacts the user database 60 to obtain authentication information and other numbers associated with the mobile terminal 20. The user database 60 authenticates mobile terminal 20 based on information received from the network switch/register 50 in a well-known manner. If the user database 60 is able to authenticate the mobile terminal 20, the user database 60 provides the network switch/register 50 with the numbers associated with the mobile terminal 20, the priority assigned to each number and the operating mode of the mobile terminal 20. The network switch/register 50 then sends an acknowledgement message to the mobile terminal 20, thereby completing the registration of the mobile terminal 20. The information provided during this registration of the mobile terminal 20 may be used by the network switch/register 50 until another registration procedure is completed. As previously described, a registration procedure may occur during activation, at regular intervals, after triggering events, etc.

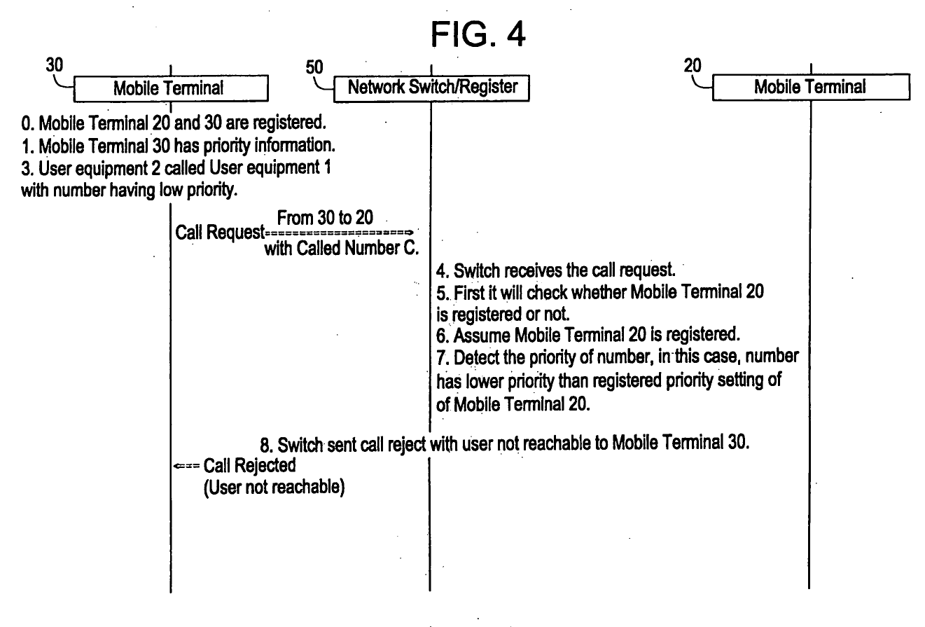

FIG. 4 illustrates the communication flow during a call made from the mobile terminal 30 to the mobile terminal 20 that is routed by the network switch/register 50 according to an example embodiment of the present invention. The example of FIG. 4 assumes that both the mobile terminal 30 and the mobile terminal 20 are registered with the network switch/register 50 and that the mobile terminal 20 has multiple, hierarchically prioritized numbers. A call is placed from the mobile terminal 30 to the low priority third number (111) 111-1113 of the mobile terminal 20. The call is received by the network switch/register 50. Assuming the mobile terminal 20 is registered with the network switch/register 50, the network switch/register 50 detects the priority setting of the mobile terminal 20. If the mobile terminal 20 priority setting is high, the network switch/register 50 rejects the call received from the mobile terminal 30 and indicates the mobile terminal 20 is unavailable as shown in FIG. 4.

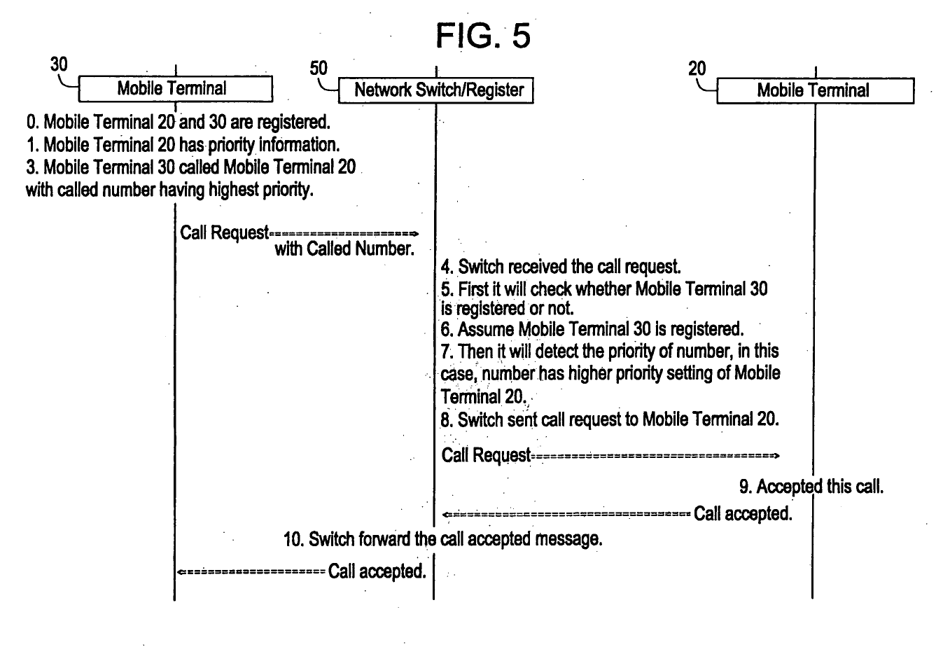

FIG. 5 also illustrates the communication flow during a call made from the mobile terminal 30 to the mobile terminal 20 that is routed by the network switch/register 50 according to an example embodiment of the present invention. The example of FIG. 5 assumes that both the mobile terminal 30 and the mobile terminal 20 are registered with the network switch/register 50 and that the mobile terminal 30 has called the mobile 20 using a number having the highest priority. For example, a call is placed from the mobile terminal 30 to the highest priority first number (111) 111-1111 of the mobile terminal 20. The call is received by the network switch/register 50. Assuming the mobile terminal 20 is registered with the network switch/register 50, the network switch/register 50 detects the priority setting of the mobile terminal 20. If the mobile terminal 20 priority setting is high, the network switch/register 50 forwards the call request to the mobile terminal 20 and the call may be accepted by the mobile terminal 20. If the call is accepted by the mobile terminal 20, the acceptance is indicated to the mobile terminal 30 and the call is connected.

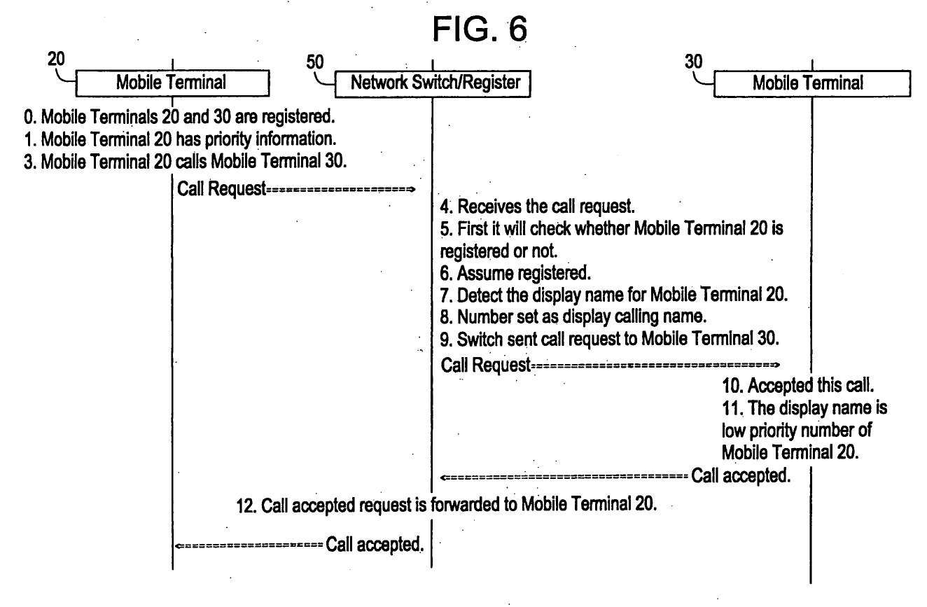

FIG. 6 illustrates communication flow during a call initiated by the mobile terminal 20 to the mobile terminal 30 that is routed by the network switch/register 50 according to an example embodiment of the present invention. The example of FIG. 6 assumes that both the mobile terminal 30 and the mobile terminal 20 are registered with the network switch/register 50 and that mobile terminal 20 is operating in a mode corresponding to a high priority setting. The user of the mobile terminal 20 initiates a call to the mobile terminal 30 by sending a call request to the network switch/register 50. Assuming the mobile terminal 20 is registered with the network switch/register 50, the network switch/register 50 detects which of the multiple numbers associated with the mobile terminal 20 should be displayed on a caller ID system of the mobile terminal 30. Based on a user input and/or a default setting, the network switch/register detects that the low priority third number (111) 111-1113 should be displayed. The network switch/register then sends the call request to the mobile terminal 30. If the call is accepted by the mobile terminal 30, the network switch/register forwards the call accepted message to the mobile terminal 20 and the call is connected.

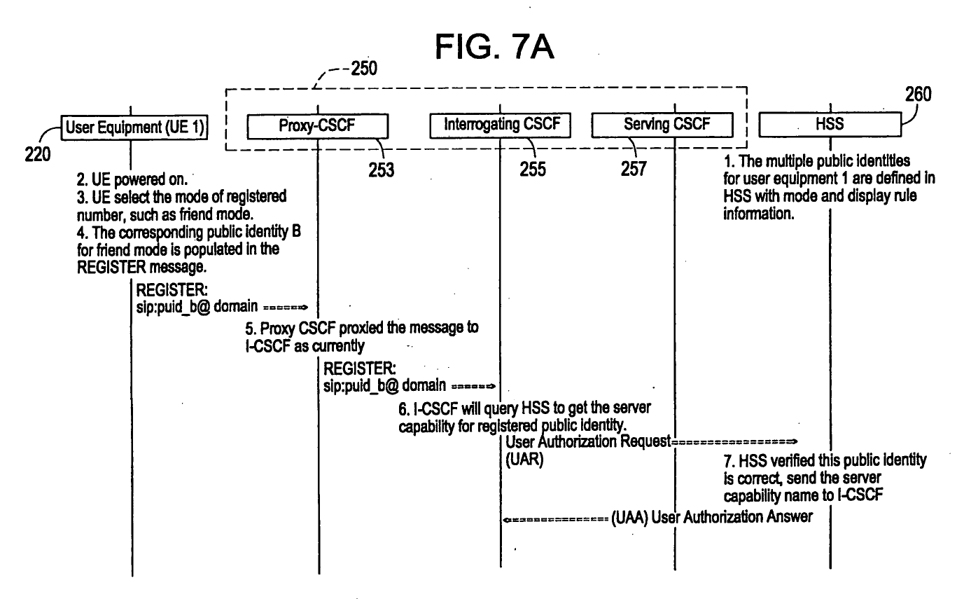

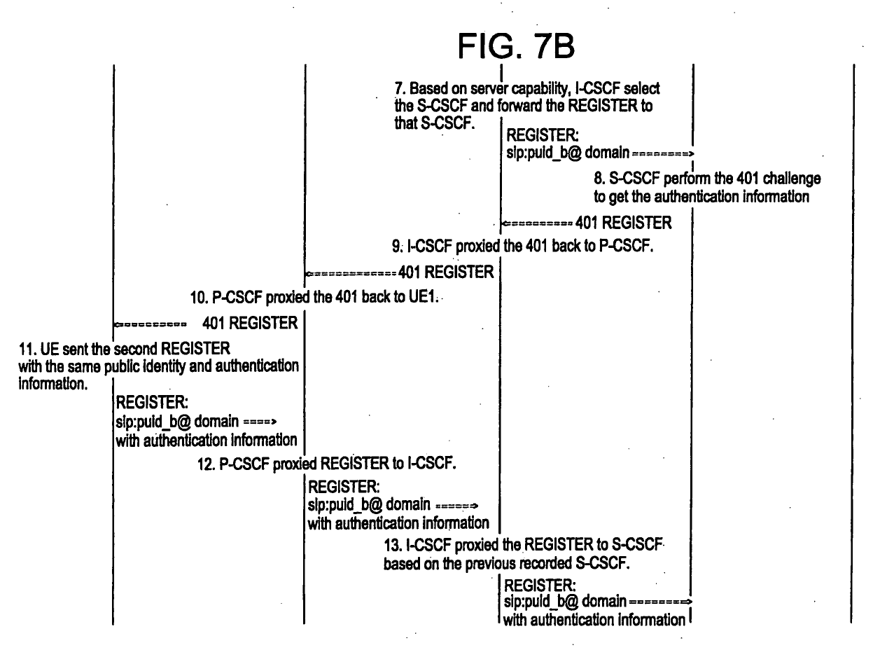

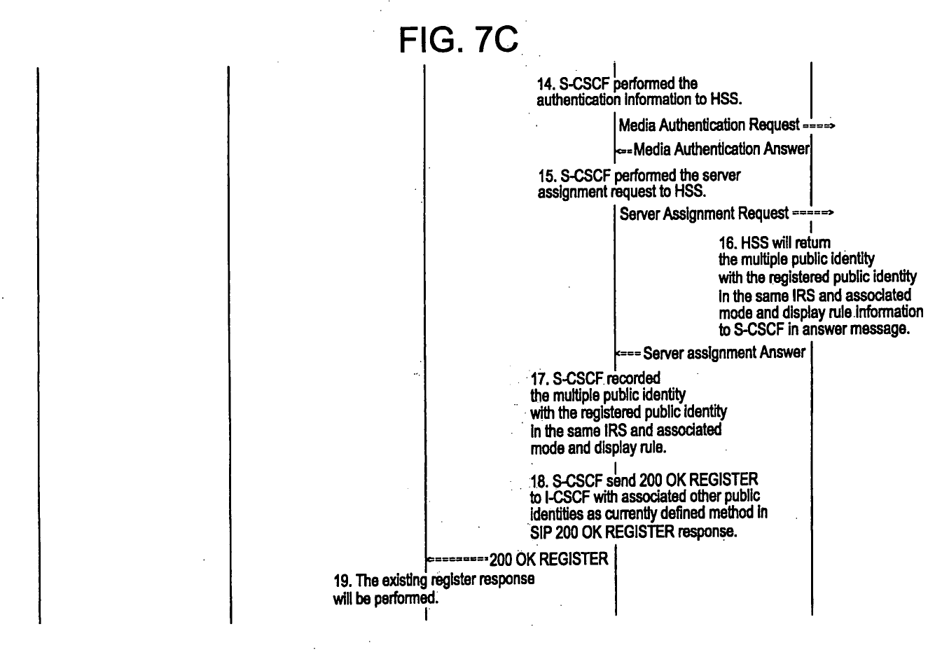

FIGS. 7A-10 described below is an example of the communication flow according to an example embodiment of the present invention in an Internet Protocol Multimedia Subsystem (IMS). The specific details of the communication flow diagrams illustrated in FIGS. 7A-10 will not be described herein because one skilled in the art will readily be able to apply teachings of the example embodiments of the present invention described above with respect to the communication flow diagrams of FIGS. 3-6 to the IMS.

One skilled in the art will understand that the IMS mobile terminal 220 functions and operates similar to the mobile terminal 20; that the CSCF 250 functions and operates similar to the network switch/register 50; and that the HSS 260 functions and operates similar to the user database 60. One skilled in the art will also understand that the CSCF 250 includes a Proxy-CSCF 253, Interrogating-CSCF 255 and Serving-CSCF 257 and the functions of the Proxy-CSCF 255, Interrogating-CSCF 255 and Serving-CSCF 257.

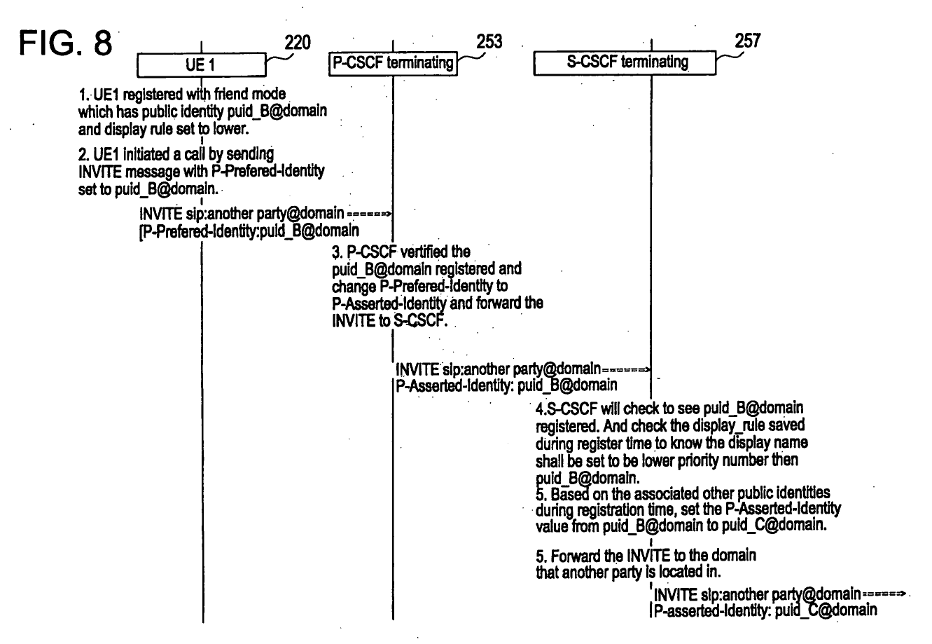

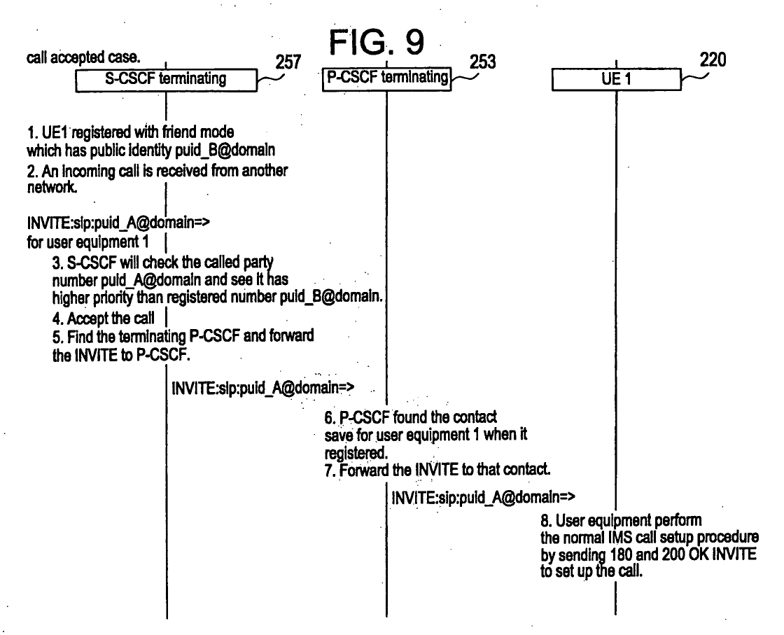

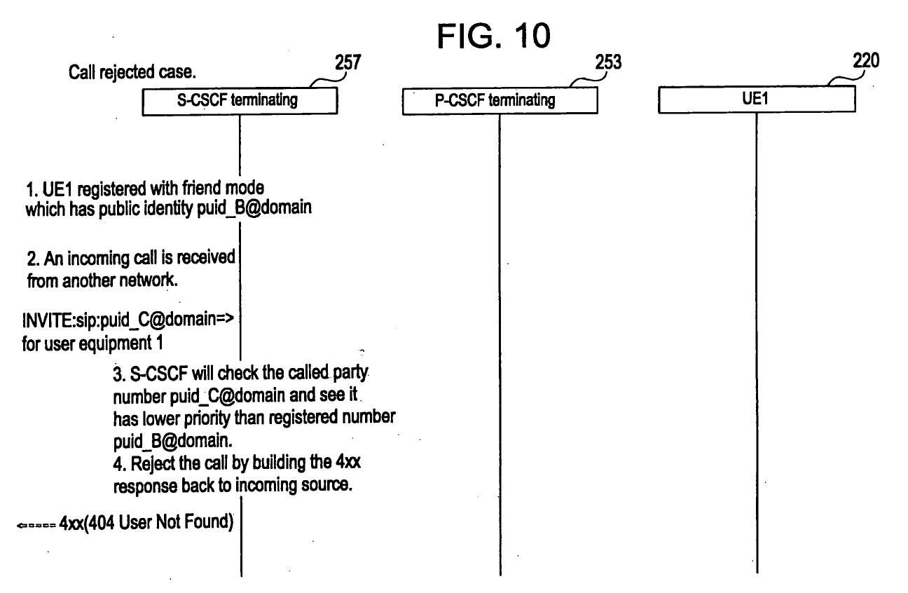

FIGS. 7A-7C is an example communication flow in an IMS during a power-on registration procedure; FIG. 8 is an example communication flow in an IMS during a call initiated by an IMS terminal 220; and FIGS. 9 and 10 are example communication flows during calls directed to the IMS terminal 220.

Example embodiments of the present invention being thus described, it will be obvious that the same may be varied in many ways. Such variations are not to be regarded as a departure from the invention, and all such modifications are intended to be included within the scope of the invention.

What is claimed:

1. A method of processing a call in a communication system comprising:
determining a priority of a received call based on a list of prioritized directory numbers associated with a called communication device; and
handling the received call based on the determining step.

2. The method of claim 1, wherein the handling step handles the received call based on the determined priority of the received call and a priority setting of the called communication device.

3. The method of claim 2, wherein the handling step comprises:
screening the received call if the determined priority of the received call is lower than the priority setting of the called communication device.

4. The method of claim 3, wherein the screening step screens the received call by at least one of providing a busy signal, disconnecting the call and playing a recorded message.

5. The method of claim 3, wherein the handling step further comprises:
sending the received call to the called communications device if the determined priority of the received call is at least one of higher than the priority setting of the called communication device and same as the priority setting of the called communication device.

6. The method of claim 2, wherein the handling step comprises:
sending the received call to the called communication device if the priority of the received call is at least one of higher than the priority setting of the called communication device and same as the priority setting of the called communication device.

7. The method of claim 2, wherein the determining step further comprises:
obtaining a subscriber record if the received call is directed to a directory number that is one of the prioritized directory numbers associated with the called communication device; and
determining the priority of the received call based on the subscriber record.

8. The method of claim 7, further comprising:
detecting the priority setting of the called communication device from the subscriber record.

9. The method of claim 2, wherein the priority setting of the called communication device is based on an operating mode of the communication device.

10. The method of claim 1, further comprising:
registering directory numbers for the called communication device;
assigning each of the directory numbers with a priority; and wherein
the determining step determines the priority of the received call based on the assigned priority of a called directory number.

11. A communication system comprising:
a user database storing prioritized directory numbers associated a called communication device and a priority of each directory number associated with the called communication device; and
a network switch handling a received call directed to one of the prioritized directory numbers based on a priority of the received call and a priority setting of the called communication device.

12. The communication system of claim 11, wherein the priority of the received call is a priority associated with the one of the prioritized directory numbers.

13. The system of claim 11, wherein the network switch screens the received call if the priority of the received call is lower than the priority setting of the called communication device.

14. The system of claim 13, wherein the network switch sends the received call to the called communication device if the priority of the received call is at least one of higher than the priority setting of the called communication device and same as the priority setting of the called communication device.

15. The system of claim 11, wherein the network switch sends the received call to the called communication device if the priority of the received call is at least one of higher than the priority setting of the called communication device and the same as the priority setting of the called communication device.

16. The communication system of claim 11, wherein the network switch includes:
a transceiver receiving a call;
a memory storing a subscriber list of directory numbers; and
a computer processing unit (CPU) determining if the received call is directed to a directory number included in the subscriber list, instructing the transceiver to obtain a subscriber record associated with the directory number from the user database if the directory number is included in the subscriber list and handling the received call based on the subscriber record.

17. The system of claim 16, wherein the subscriber record indicates if prioritized directory numbers are associated with a communication device associated with the directory number and a priority of the directory number used as the priority of the received call.

18. The system of claim 17, wherein the CPU handles the received call by detecting a priority setting of the called communication device, comparing the priority setting of the called communication device to the priority of the received call, and sending the received call to the communication device if the priority of the received call is at least one of the same and higher than the priority setting of the communication device.

19. The system of claim 17, wherein the CPU processes the received call by detecting a priority setting of the called communication device, comparing the priority setting of the called communication device to the priority of the received call, and screening the received call if the priority of the received call is lower than the priority setting of the called communication device.

20. The system of claim 19, wherein CPU screens the received call by at least one of providing a busy signal, disconnecting the received call and playing a recorded message.

21. The method of claim 1, wherein the communication system is an Internet Protocol Multimedia Subsystem (IMS).
